(19) United States
(12) Patent Application Publication
(10) Pub. No.: US 2013/0004928 A1
(43) Pub. Date: Jan. 3, 2013

(54) REACTION TRAINING APPARATUS AND METHODS OF USE

(76) Inventor: Jesse Ackerman, Gainesville, FL (US)

(21) Appl. No.: 13/363,167

(22) Filed: Jan. 31, 2012

Related U.S. Application Data
(60) Provisional application No. 61/438,224, filed on Jan. 31, 2011.

(51) Int. Cl. G09B 5/00

(52) U.S. Cl. 434/322

(57) ABSTRACT

The present invention includes a reactive training apparatus and methods of training designed to utilize special physical-preparation means to develop and/or enhance a sport-specific or task-specific motor ability. The reactive training apparatus includes a display which displays target objects and clutter objects. A trainee reacts to these objects in various ways, and these reactions may be recorded and analyzed to improve the trainee's reactions. The present invention may be used to enhance the biomechanical efficiency, reaction time, and accuracy of a trainee.

### RELATED APPLICATIONS

This application claims priority to U.S. Provisional Application No. 61/438,224 filed Jan. 31, 2011 which is hereby incorporated herein by reference in its entirety.

### FIELD OF THE INVENTION

The present invention relates generally to a training device and methods of its use. More specifically, the present invention relates to a reaction training apparatus using visual stimulation and biomechanical feedback sensors and methods of its use.

### BACKGROUND

Many individuals perform tasks which require visual acuity and discrimination of a confusing vista coupled with swift and accurate reactions. Professional athletes, soldiers, police officers, and the like are often confronted with such situations. Other individuals may need to relearn basic behavioral tasks and movements after a debilitating injury through some form of physical therapy.

For example, a quarterback needs to be able to see the whole playing field and determine what the opposing team's players are doing. When a quarterback drops back to throw a pass, he needs to not only know where his receivers are, but also where the defensive players are. If the quarterback's primary target is covered, he needs to be able to go through his progressions to find an open receiver. While going through his progressions, the quarterback attempts to use his peripheral vision as much as possible to prevent the defense from knowing where he intends to throw the ball.

In another example, a police officer needs to be able to identify and track innocents and criminals. Especially in situations involving a drawn weapon, an officer must be able to discriminate threats (e.g. an armed gunman) from other individuals or movements. An incorrect assessment may lead to an inappropriate discharge causing unnecessary injury or death, while a delayed reaction may result in a successful attack on the officer or others.

### SUMMARY OF INVENTION

The present invention includes a reactive training apparatus and methods of training designed to utilize special physical-preparation means to develop and/or enhance a sport-specific or task-specific motor ability. Principles of the present invention are based on the conjugate-sequential or coupled successive system of training in which one or two abilities are targeted in concentrated blocks of training to enhance a specific motor task. The implementation of this system of training has been used with great success in the process of achieving sports mastery with many advanced athletes. The present invention may be used to enhance the biomechanical efficiency, reaction time, and accuracy of a trainee.

According to one aspect of the present invention, a method of providing reactive training to a trainee in a reactive training apparatus—the reactive training apparatus including at least one display configured to display a plurality of target and clutter objects—includes displaying the plurality of target objects and the plurality of clutter objects to the trainee, recording speed and accuracy of a count of the target objects made by the trainee, and providing feedback to the trainee.

According to another aspect, the trainee remains in a neutral position during the count, thereby using his/her peripheral vision to make the count.

According to another aspect, target and clutter objects include symbols, alphanumeric characters and/or complex figures.

According to another aspect, the target and clutter objects are differentiated by orientation, shape, size and/or color.

According to another aspect, the speed and accuracy are recorded by a camera and/or an accelerometer.

According to another aspect, the recording includes recording an emission from a handheld or head-mounted emitter.

According to another aspect of the invention, a method of providing reactive training to a trainee in a reactive training apparatus—the reactive training apparatus including at least one display configured to display a plurality of target and clutter objects—includes displaying a plurality of target objects and a plurality of clutter objects to a trainee, indicating one or more selected target objects for the trainee to react to, measuring a biomechanical response of a trainee to the one or more selected target objects, analyzing the biomechanical response of the trainee, and providing feedback to the trainee.

According to another aspect, the target and clutter objects include symbols, alphanumeric characters and/or complex figures.

According to another aspect, the target and clutter objects are differentiated by orientation, shape, size and/or color.

According to another aspect, the biomechanical response is recorded by a camera and/or an accelerometer.

According to another aspect, the biomechanical response includes orienting the trainee towards the selected target object.

According to another aspect, the biomechanical response includes flicking a wrist of the trainee towards the selected target object.

According to another aspect, the biomechanical response includes activating a handheld emitter so as to illuminate the selected target object.

According to another aspect of the invention, a method of providing reactive training to a trainee in a reactive training apparatus—the reactive training apparatus including at least one display configured to display a plurality of target and clutter objects—includes displaying a plurality of target objects and a plurality of clutter objects to a trainee, consecutively indicating selected target objects for the trainee to react to, measuring a biomechanical response of a trainee to each selected target object, analyzing the biomechanical responses of the trainee, and providing feedback to the trainee.

According to another aspect, the target and clutter objects include symbols, alphanumeric characters and/or complex figures.

According to another aspect, the target and clutter objects are differentiated by orientation, shape, size and/or color.

According to another aspect, the biomechanical responses are recorded by a camera and/or an accelerometer.

According to another aspect, the biomechanical responses include orienting the trainee towards the consecutively selected target objects.

According to another aspect, the last biomechanical response includes flicking a wrist of the trainee towards the last selected target object.

According to another aspect, the last biomechanical response includes activating a handheld emitter so as to illuminate the selected target object.

The foregoing and other features of the invention are hereinafter described in greater detail with reference to the accompanying drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagram illustrating an exemplary reactive training apparatus in accordance with aspects of the present invention.

FIG. 2 is a diagram illustrating an exemplary reactive training apparatus in accordance with aspects of the present invention.

FIG. 3 is a diagram illustrating an exemplary reactive training apparatus in accordance with aspects of the present invention.

FIG. 4 is a diagram illustrating an exemplary reactive training apparatus in accordance with aspects of the present invention.

FIG. 5 is a diagram illustrating an exemplary reactive training apparatus in accordance with aspects of the present invention.

FIG. 6 is a diagram illustrating an exemplary reactive training apparatus in accordance with aspects of the present invention.

FIG. 7 is a diagram illustrating a top view of an exemplary reactive training apparatus in accordance with aspects of the present invention.

FIG. 8 is a diagram functionally illustrating an exemplary reactive training controller in accordance with aspects of the present invention.

FIG. 9 is a block diagram illustrating a method of training consistent with aspects of the present invention.

FIG. 10 is a block diagram illustrating a method of training consistent with aspects of the present invention.

FIG. 11 is a block diagram illustrating a method of training consistent with aspects of the present invention.

### DETAILED DESCRIPTION

The present invention may be used to enhance the biomechanical efficiency, reaction time, and accuracy of a trainee.

Biomechanical efficiency may be enhanced, for example, by training an individual to move his body in a manner that accomplishes a task in the quickest time possible, with the least energy expenditure, with the least damage to body tissues, or some combination of these or other concerns.

Reaction time, as used herein, may mean, for example, the elapsed time between the presentation of a sensory stimulus and a subsequent behavioral response. In other words, response time indicates how fast an individual can execute the mental operations needed by the task at hand, and physically react accordingly. Reaction time, as used herein, may indicate any of the following types of reaction time: 1) Simple reaction time is the time required for an individual to respond to the presence of a stimulus. 2) Go/No-Go reaction time requires that an individual respond when one stimulus type appears and withhold a response when another stimulus type appears. 3) Choice reaction time requires an individual to distinctly respond to different classes of stimulus. For example, an individual should push a left button when presented with a red object and a right button when presented with a blue object. 4) Discrimination reaction time requires an individual to respond to various qualities of simultaneously presented stimuli. For example, an individual may be presented with two objects and then be required to press one of two buttons according to which object appears brighter. Various training exercises may be used to train and assess these various types of reaction time in accordance with the present invention.

Accuracy may refer, in different contexts, to correctly discerning objects presented to an individual, or to precisely orienting the body (or a portion thereof) of an individual based on the presentation of an object during a training exercise.

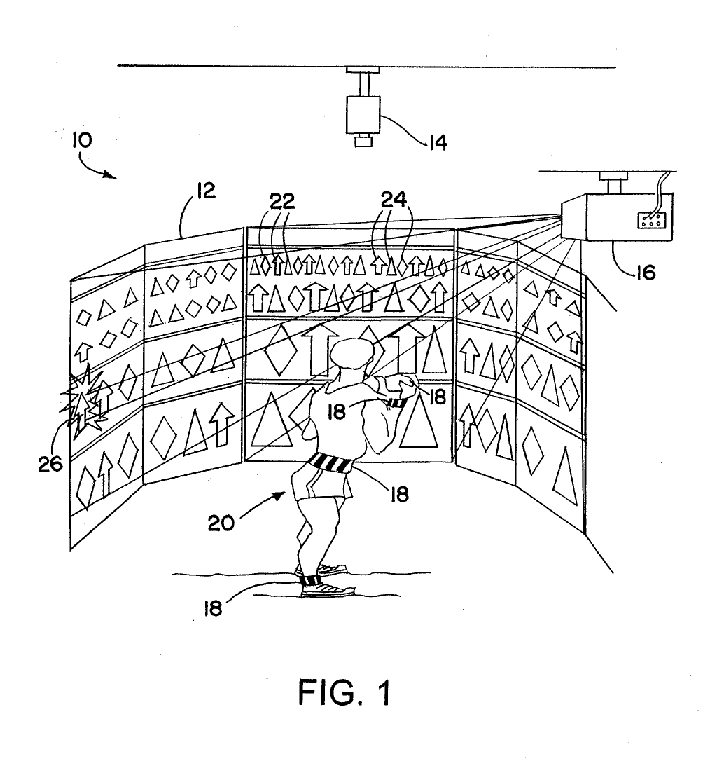

Referring initially to FIG. 1, shown are exemplary reactive training apparatuses 10 in accordance with aspects of the present invention. The reactive training apparatus may include a display 12, a camera 14, a projector 16, and one or more biomechanical sensors 18 used to train a trainee 20. The reactive training apparatus may also include a reactive training controller 40 as functionally depicted in FIG. 3 which may act to control and/or monitor aspects of the present invention.

In some embodiments of the present invention, the display 12 takes up all, or substantially all, of the trainee's 20 field of view. In other embodiments, the display 12 extends to the periphery of the trainee's 20 vision. In yet other embodiments, the display 12 surrounds the trainee 20 along a horizon and is shaped similar to a hollow cylinder or hollow spherical segment. In still another embodiment, the display 20 surrounds the trainee 20 in an approximate half-sphere dome. In another embodiment, the display 12 moves with the trainee 20, for example, as a head-mounted display.

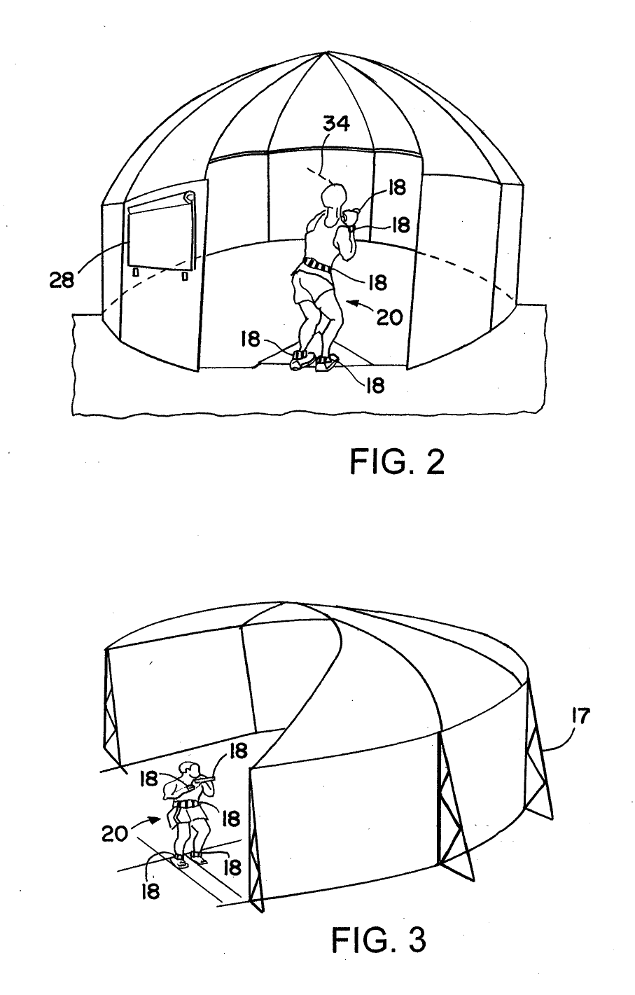

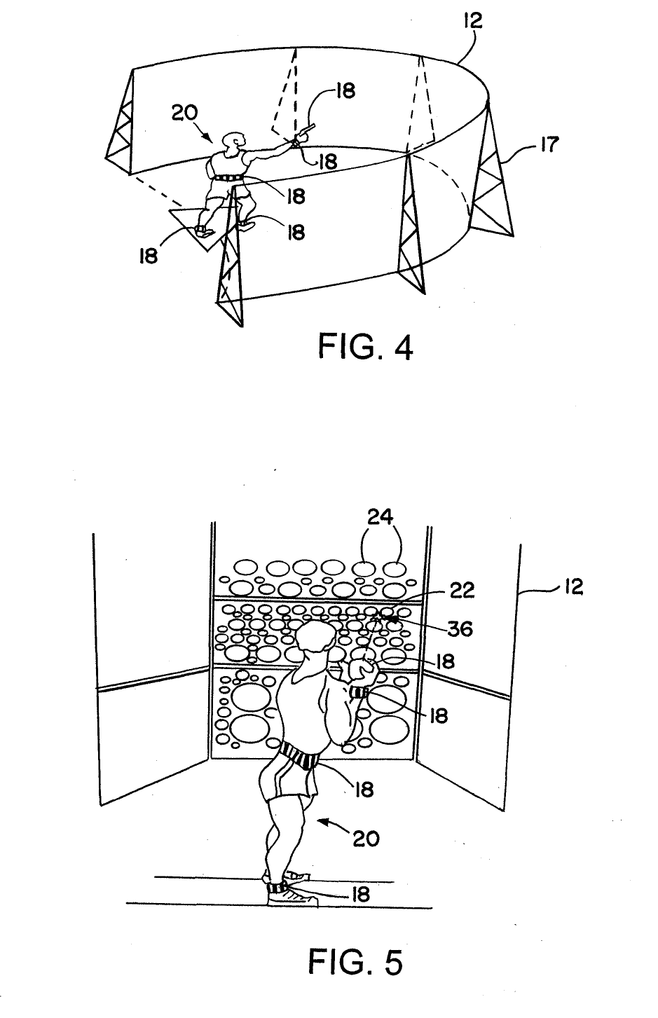

As shown in FIGS. 1-6, the display 12 may be a fixed medium such as poster board, canvas, corrugated plastic, or the like. Alternatively, the display 12 may be a dynamic medium such as a rear or front mounted projection screen with a projector 16, one or more LCD monitors, heads-up display, or the like. The display 12 may be attached to the walls of a structure or may be held in place by supports 17, shown in FIGS. 2 and 4, attached to or resting on a floor. The display 12 may be a tent-like structure as shown in FIG. 2, or self-supported by means of one or more inflated bladders. The display 12 may also include an observation window 28 for viewing a training exercise, or to allow the camera 14 or the projector 16 access to the display 12. The display 12 may be made of separate panels, and these panels may represent, for example, different segments of a playing field or a firing range.

The display 12 may display target objects 22 and clutter objects 24 (clutter objects being any objects displayed which are not target objects 22). These objects 22, 24 may be symbols such as arrows, triangles, diamonds, and the like; alphanumeric characters; or complex figures such as humans, animals, automobiles, and the like. The objects 22, 24 may have varied attributes such as color, shape, orientation, size and the like. The objects 22, 24 may be stationary, may move, or may change their movement over time. During a training session, the objects 22, 24 may appear, disappear, move, and change attributes (e.g. change size). The objects 22, 24 may be attached to the display 12 by, for example, tape, hook and loop fasteners, magnets, or the like. Alternatively, the objects 22, 24 may be displayed using electromagnetic means such as visual projection and the like.

The objects 22, 24 may be used as abstract representations analogous to various stimuli encountered by the trainee 20 in his job or sport. For example, the objects 22, 24 may be imbued with qualities such as color and movement that mimic patterns seen by a quarterback during a football game. Some clutter objects 24 may be colored, sized, and given movement similar to defensive players or even offensive players who are not receivers. Other clutter objects 24 may be more akin to fans, referees, or even a flock of birds flying over the field. Target objects 22 may have attributes similar to offensive receivers. Objects 22, 24 that are higher and smaller may represent, for example, players farther down the field. Alternatively, the objects 22, 24 may be more abstract and bear little to no relation to elements encountered in a job or sport, while still being used to train skills relevant for the job or sport.

The reactive training apparatus 10 may include a camera 14 for various purposes. The camera 14 may be used to record training sessions for later analysis and archiving. Additionally or alternatively, the camera 14 may be coupled to a reactive training controller 40 adapted to run image processing software and used as a biomechanical sensor 18. To assist in this function, reflective tape, reflective balls, or the like, may be worn by the trainee 20, as is known in the art, for easier identification of body position and movement. For instance, the camera 14 may be used to observe the positions and reaction time of the trainee's 20 body. Image processing software may be used to build and render wire-frame or skeletal representations of the trainee 20 that may be reviewed by the trainee 20, a coach, a doctor, or other person able to evaluate the biomechanical states and movement of the trainee's 20 body.

The camera 14 may be positioned anywhere advantageous to the specific use of the camera 14 during a training exercise. In some embodiments, for example, the camera 14 is positioned above the trainee 20 and is oriented to look down on the trainee 20. In other embodiments, for example, the camera 14 is positioned in front of the trainee 20 and is oriented to look towards the trainee 20. Multiple cameras may be used separately for different tasks, or together for producing three-dimensional image data of the trainee 20. The camera 14 may be, for example, a visible-spectrum camera, an infrared camera, an ultra violet camera, an X-ray imager, or the like.

The projector 16 may be the primary means of displaying the objects 22, 24. In addition, or alternatively, the projector 16 may be used to indicate a selected target object 26 by, for example, highlighting or otherwise shining light on or near a target object 22. The projector 16 may project light in such a way as to provide other means of distraction to trainee 20, for example, by acting as a strobe light, by flashing complex laser patterns on display 12, or the like. The projector 16 may be, for example, an LCD or LED projector, a laser pointer device, a strobe light, or the like.

Biomechanical sensors 18 may be disposed on or around the trainee 20 and may take the form of, for example, accelerometers, gyros, lasers, force sensors, push-buttons, heart rate monitors, blood oxygenation monitors, and the like. A biomechanical sensor 18 may take the form of a reflective or otherwise distinctive marking used in conjunction with the camera 14 and image processing software run on the reactive training controller 40 to determine the position of the trainee 20 as is known in the art. The trainee 20 may hold a biomechanical sensor 18 that is representative of an object integral to a task performed by the trainee 20. For example, a biomechanical sensor 18 may be an analogue of a football, firearm, or the like. In one embodiment, a biomechanical sensor 18 is a device analogue (such as a gun or other firing/shooting apparatus) which includes a laser (or other remote marking means) that may be activated by the trainee 20, may be continually active during a training session, or may be activated by the reactive training controller 40.

The light emitted from a gun-like biomechanical sensor, for example, may be recorded and assessed to determine accuracy and/or reaction time. For example, a police officer or soldier may use a pistol modified to emit a laser beam when triggered. The laser beam may illuminate selected target objects to mimic a reaction of the police officer/soldier firing upon a hostile individual. The speed of the reaction may be assessed. Additionally, the accuracy may be assessed by, for example, registering a hit on the object/hostile individual and/or by registering the anatomical location of the simulated bullet strike on the hostile individual.

Referring now to FIG. 7, shown is a top-view of a reactive training apparatus 10 in accordance with aspects of the present invention. The position of the trainee 20 may be monitored and described in a variety of ways. An imaginary line running from the trainee 20 to the display 12, perpendicular to a belt buckle location on the hips of the trainee 20, defines a ventral axis 30. In line with the shoulders of the trainee 20 is an imaginary line defining a lateral axis 32. Further, an imaginary line running straight out from the face of the trainee 20 defines a facial axis 34. Further still, the trainee 20 may be equipped with a biomechanical sensor 18 which includes a laser that may project a beam of light at the display 36. This beam may define an execution point 36 which corresponds, for example, to a location the trainee 20 has decided to throw a football to, shoot a gun at, throw a punch towards, or otherwise execute a task in the vicinity of. If the reactive training apparatus is equipped with a means of tracking the eyes of the trainee 20, the location on the display 12 where the trainee's 20 eyes are focused defines a focus point 38.

The location and orientation of the trainee 20 may be recorded and monitored by the reactive training controller 40 using these and/or other indicators. For example, a training exercise for a quarterback may require the trainee 20 to orient on a selected target object 26, and execute a task (e.g., a wrist-flick captured by a wrist-mounted accelerometer, which is a less physically demanding analogue to a football pass) towards the selected target object 26. The reactive training controller 40 may use an overhead camera 14 to determine a lateral axis 32 and a facial axis 34, may use a biomechanical sensor 18 including a belt mounted laser to determine a ventral axis 30, may use a helmet-mounted camera to determine a focus point 38, and may use a football analogue with a laser activated by the trainee 20 to determine an execution point 36. The relation of these parameters may be analyzed, for example, by the reactive training controller 40 to determine reaction times and correct body placement. In this example, a quarterback would need to react to a selected target object 26 just as he would react to a receiver in a football game. The quarterback may, for example, want the facial axis 34 and even the focus point 38 to be located away from the selected target object 26 in order to fool the defense. In contrast, the quarterback may, for example, want to orient the ventral axis 30 away (e.g. 90 degrees from) from the selected target object 26 while aligning the lateral axis 32 with the selected target object 26. Finally, the quarterback may want to locate the execution point 36 some distance to the side and above the selected target object 26 in order to mimic leading a receiver.

In other examples, however, the trainee 20 may strive to align and position these axes and points in other arrangements as determined to be most helpful for a given training exercise. Various training exercises may be more or less related to occupational or other tasks the trainee 20 may have to perform in a job or sport as described further below in reference to FIGS. 9, 10, and 11.

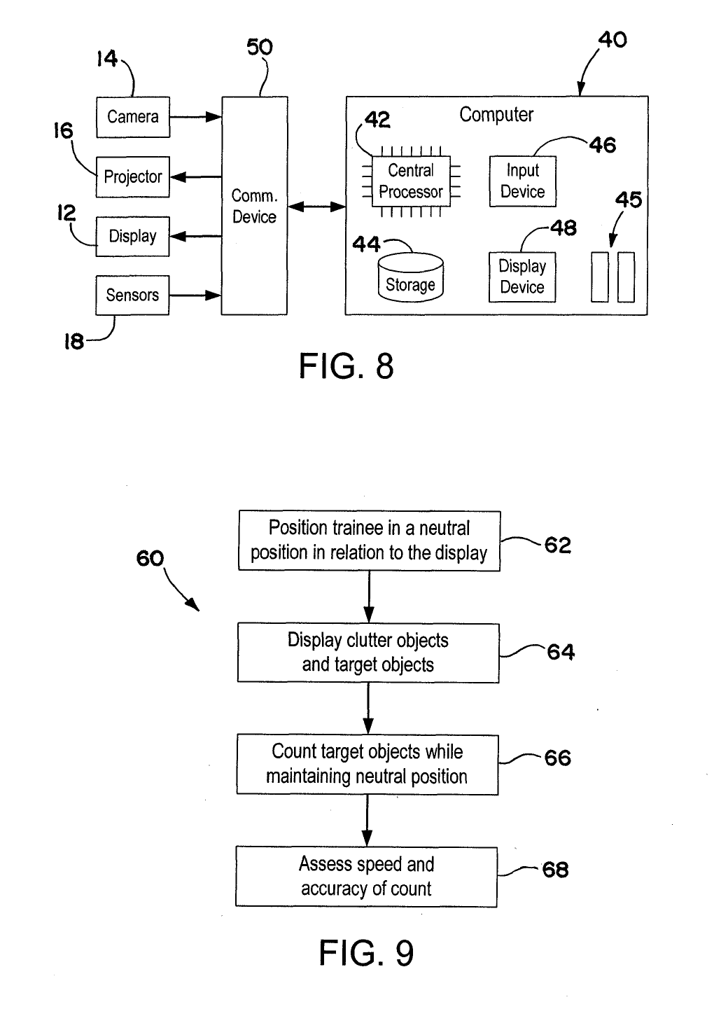

Referring now to FIG. 8, shown is a functional illustration of a reactive training controller 40 in accordance with aspects of the present invention. Although no reactive training controller 40 may be needed to utilize other aspects of the present invention, its inclusion allows for more precise measurement and control of any given training exercise. The reactive training controller 40 may be, for example, a common desktop or laptop computer which may include a central processing unit 42, a storage 44 (e.g., a hard disk drive or the like), memory modules 45 (e.g., Random Access Memory (RAM) or the like), input devices 46 (e.g., mouse, keyboard, and the like), and a display device 48 (e.g., monitor or the like). Other devices utilized with the reactive training apparatus 10 (camera 14, projector 16, display 12, and/or biomechanical sensors 18) may communicate with the reactive training controller 40 through a communications device 50 (e.g., a wireless modem or the like).

The storage 44 may be used to store measurements and other data collected by the camera 14 and the biomechanical sensors 18. The storage 44 may also store training programs as software code. These training programs may also be stored on external drives or disks or stored in a cloud on a network connected to the reactive training controller 40 through a network connection without departing from the present invention. The storage 44 may be physically connected to the reactive training controller 40 (e.g. an internal drive or a universal serial bus (USB) connected external drive) or may be accessed through a network connection via the communications device 50.

Various training programs may be executed by the reactive training controller, but the main focus of these training exercises is on General Physical Preparation (GPP) and Special Physical Preparation (SPP), as opposed to Sport-Specific Preparation. GPP exercises are conditioning exercises designed to enhance the trainee's 20 general, non-specific work capacity. SPP is training specific to the sport or task requirements of the competition or job that the trainee 20 is training for. SSP are drills or exercises that enhance or refine abilities specific to that sport or task (e.g., throwing drills during practice, practicing steps leading to long or high jump, tackling drills, scrimmages, and the like).

The present invention works with these principles to isolate the trainee 20 from complications (both distractions and the more physically demanding/damaging movements) associated with SSP and to focus on training more generalized skills related to dynamic recognition that will translate back into increased performance in execution of the trainee's 20 trained-for tasks. Three exemplary training methods are illustrated below in reference to FIGS. 9, 10, and 11, and are based on training four key, generalized skills: 1) Eye scan: the act of finding the appropriate stimulus amongst various stimuli. 2) Sight positioning: position in a biomechanically efficient position to target the appropriate stimulus. 3) Target lock: focus in on appropriate stimulus. 4) Strike: the initiation of movement to execute an action (such as shoot or throw) towards the target.

Referring now to FIG. 9, shown is a training method in accordance with aspects of the present invention. This neutral position eye scan method 60 may help in training visual discrimination speed and accuracy, especially in the periphery of the trainee's 20 field of view.

At block 62, the trainee 20 may be placed in a neutral position in relation to the display 12. For example, the trainee 20 may stand at the center point of a circle defined by a semi-circle display 12. The trainee 20 may align the ventral axis 30 and facial axis 34 with the center of the display 12, and the lateral axis 32 with the ends of the display 12.

At block 64, clutter objects 24 and target objects 22 are displayed on the display. For example, various objects 22, 24 may be displayed on the display 12, and a description of the target objects 22 is communicated to the trainee 20. In this example, a speaker may announce to the trainee 20 that all orange triangles are target objects 22. In an alternative embodiment, prior to displaying all of the objects 22, 24, a red arrow is briefly displayed on the display 12, indicating to the trainee 20 that all red arrows subsequently displayed in this training exercise are target objects 22.

At block 66, the trainee 20 may attempt to count the target objects 22 while maintaining a neutral position. In other words, the trainee 20 may attempt to use his peripheral vision to count the target objects 22.

At block 68, the speed and accuracy of the trainee's 20 counting may be assessed. This assessment may be performed by the trainee 20, by a trainer, or by the reactive training controller 40.

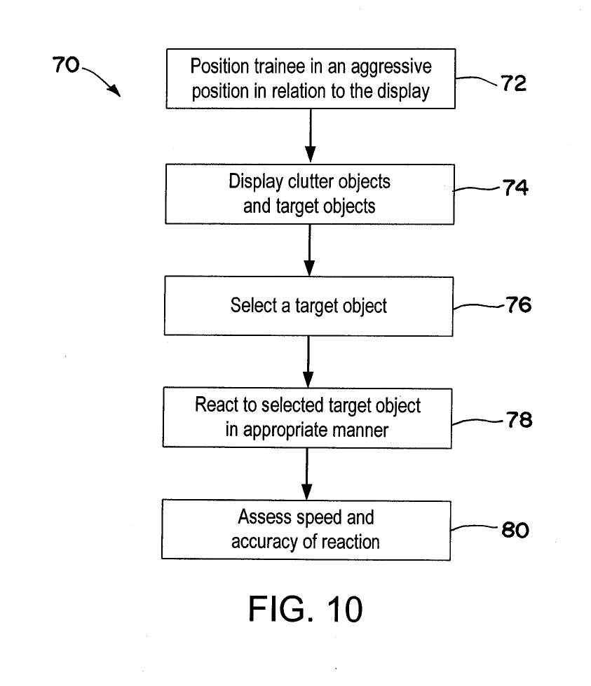

Referring now to FIG. 10, shown is a block diagram of a method of training consistent with aspects of the present invention. This method of training dynamic reaction to target position 70 may help to train skills such as visual discrimination, reaction time, biomechanical efficiency, and biomechanical accuracy.

At block 72, the trainee 20 may be placed in an aggressive position in relation to the display 12. For example, the trainee 20 may stand at the center point of a circle defined by a semi-circle display 12. The trainee 20 may take a stance appropriate to a job or sport task (e.g. a quarterback throwing stance, a pistol firing stance, and the like).

At block 74, clutter objects 24 and target objects 22 are displayed on the display 12 as described in reference to block 64.

At block 76, a target object 22 is selected. The selection may occur by any method known in the art. Examples of selecting or designating objects include shining a laser beam on or near the target object 22, enlarging the target object 22, increasing the brightness of the target object 22, making the target object 22 flash, and the like.

At block 78, the trainee 20 reacts to the selected target object 26. For example, a police officer trainee may train a weapon on the selected target object 26, or a quarterback may orient himself towards the selected target object 26. A reaction to the selected target object 26 may or may not include an execution of a task, such as firing a firearm or throwing a football.

At block 80, the speed and accuracy of the trainee's 20 reaction may be assessed. This assessment may be performed by the trainee 20, by a trainer, or by the reactive training controller 40. The assessment may include, for example, the orientation of the trainee's 20 body in relation to the selected target object 26, the speed with which the body reoriented itself, the efficiency of the movements used to achieve the new orientation, and the like.

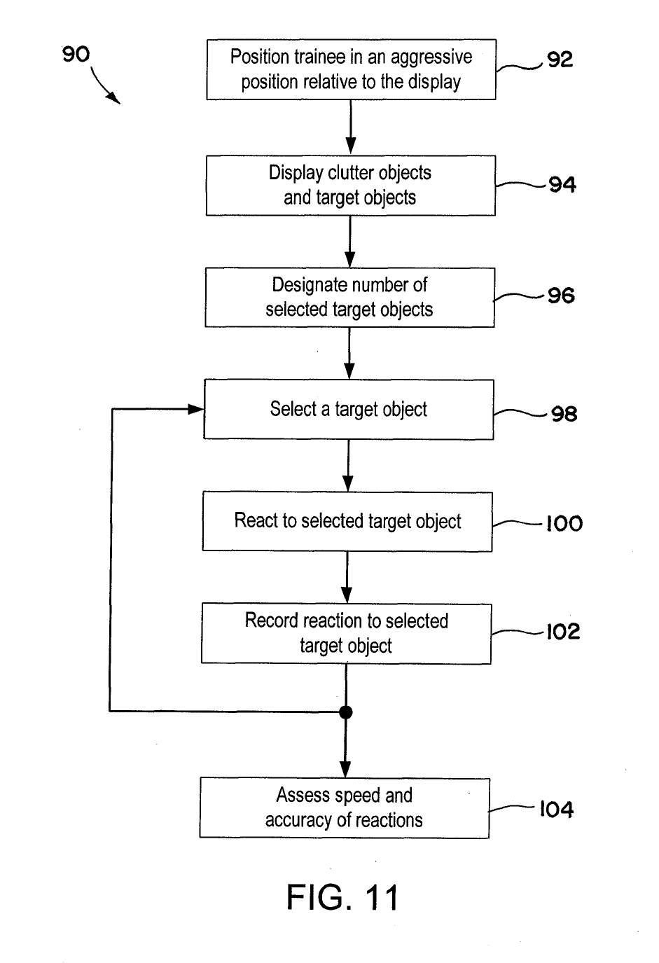

Referring now to FIG. 11, shown is a block diagram of a method of training consistent with aspects of the present invention. This method of training dynamic recognition 90 may help to train skills such as visual discrimination, multiple object tracking, reaction time, biomechanical efficiency, and biomechanical accuracy.

At block 92, the trainee 20 may be placed in an aggressive position in relation to the display 12. For example, the trainee 20 may stand in the center point of a circle defined by a semi-circle display 12. The trainee 20 may take a stance appropriate to a job or sport task (e.g. a quarterback throwing stance, a pistol firing stance, or the like). Alternatively, the trainee 20 may mimic the movements of his sport or job tasks before or during the training exercise. For example, a quarterback may start several steps toward the display and then drop back into an imaginary pocket at the center of the display 12.

At block 94, clutter objects 24 and target objects 22 are displayed on the display 12 as described in reference to block 64.

At block 96, the number of target objects 22 is designated. This block may be analogous, for example, to knowing the number of progressions or possible receivers a quarterback has during a specific play.

At block 98, a target object 22 is selected as described in reference to block 76.

At block 100, the trainee 20 reacts to the selected target object 26 as described in reference to block 78.

At block 102 the reaction to the selected target object 26 is recorded, for example, by the reactive training controller 40.

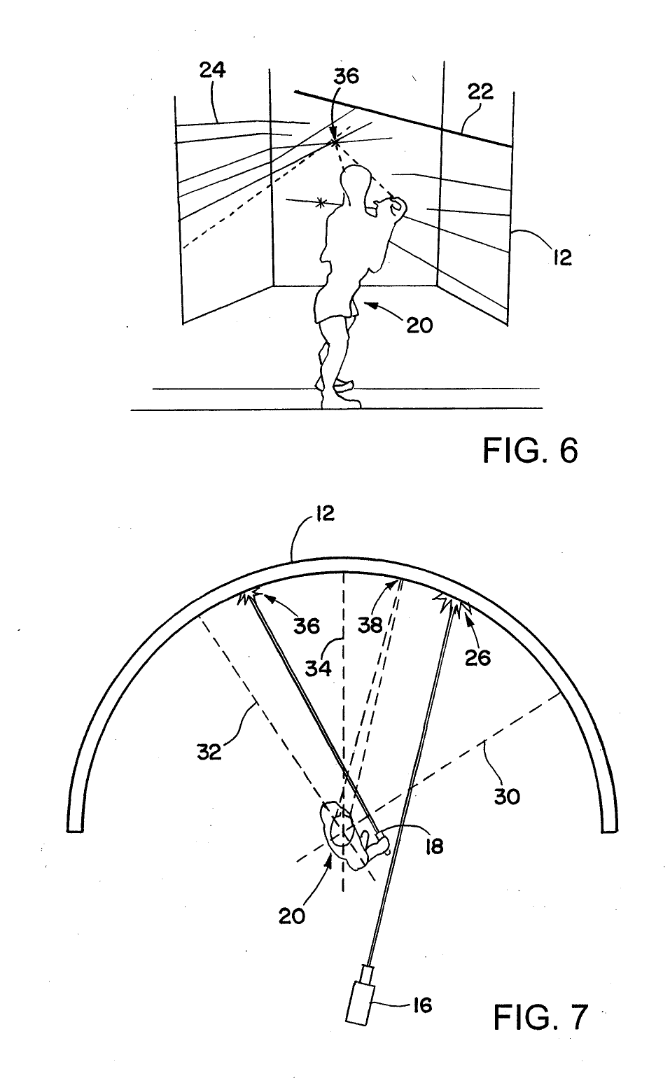

If there are more target objects 22 that need to be selected during this training exercise, the blocks, 98, 100, and 102 are repeated as shown in FIG. 6, until no more target objects 22 need to be selected.

At block 104, the speed and accuracy of the trainee's 20 reactions may be assessed as described in reference to block 80.

Other designated variables during a given training exercise may include, for example, the number of flashes that will occur during a training exercise before the selection of a target object 22; the number of flashes on a target object 22 required to designate that target object 22 as a selected target object 26; the number of flashes on objects 22, 24 having particular characteristics before objects 22, 24 having those characteristics are designated as a target objects 22; and the like. Training exercises may include, for example, visual scans over a particular shape, any number of flashes with multiple lasers, different flashes on a particular target object 22 with multiple lasers, multiple lasers scanning over objects 22, 24 with particular characteristics, and the like.

Although the illustrated methods illustrate a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application. Further, some embodiments may include multiple instances of an element (e.g. cameras 14, biomechanical sensors 18, etc.) even though only a fixed number (e.g., one) may be discussed herein, and such embodiments are understood to be within the scope of the present invention. The present invention includes all such equivalents and modifications, and is limited only by the scope of the following claims.

What is claimed is:

1. A method of providing reactive training to a trainee in a reactive training apparatus, the reactive training apparatus including at least one display configured to display a plurality of target and clutter objects, the method comprising:
displaying the plurality of target objects and the plurality of clutter objects to the trainee;
recording speed and accuracy of a count of the target objects made by the trainee; and
providing feedback to the trainee.

2. A method according to claim 1, wherein the trainee remains in a neutral position during the count, thereby using his/her peripheral vision to make the count.

3. A method according to claim 1, wherein the target and clutter objects include symbols, alphanumeric characters and/or complex figures.

4. A method according to claim 1, wherein the target and clutter objects are differentiated by orientation, shape, size and/or color.

5. A method according to claim 1, wherein the speed and accuracy are recorded by a camera and/or an accelerometer.

6. (canceled)

7. A method of providing reactive training to a trainee in a reactive training apparatus, the reactive training apparatus including at least one display configured to display a plurality of target and clutter objects, the method comprising:
displaying a plurality of target objects and a plurality of clutter objects to a trainee;
indicating one or more selected target objects for the trainee to react to;
measuring a biomechanical response of a trainee to the one or more selected target objects;
analyzing the biomechanical response of the trainee; and
providing feedback to the trainee.

8. A method according to claim 7, wherein the target and clutter objects include symbols, alphanumeric characters and/or complex figures.

9. A method according to claim 7, wherein the target and clutter objects are differentiated by orientation, shape, size and/or color.

10. A method according to any claim 7, wherein the biomechanical response is recorded by a camera and/or an accelerometer.

11. A method according to claim 7, wherein:
the biomechanical response includes orienting the trainee towards the selected target object.

12. The method of claim 7, wherein:
the biomechanical response includes flicking a wrist of the trainee towards the selected target object.

13. (canceled)

14. A method of providing reactive training to a trainee in a reactive training apparatus, the reactive training apparatus including at least one display configured to display a plurality of target and clutter objects, the method comprising:
displaying a plurality of target objects and a plurality of clutter objects to a trainee;
consecutively indicating selected target objects for the trainee to react to;
measuring a biomechanical response of a trainee to each selected target object;
analyzing the biomechanical responses of the trainee; and
providing feedback to the trainee.

15. A method according to claim 14, wherein the target and clutter objects include symbols, alphanumeric characters and/or complex figures.

16. A method according to claim 14, wherein the target and clutter objects are differentiated by orientation, shape, size and/or color.

17. A method according to claim 14, wherein the biomechanical responses are recorded by a camera and/or an accelerometer.

18. A method according to claim 14, wherein:
the biomechanical responses include orienting the trainee towards the consecutively selected target objects.

19. A method according to claim 14, wherein:
the last biomechanical response includes flicking a wrist of the trainee towards the last selected target object.

20. (canceled)
